(19) United States
(12) Patent Application Publication
(10) Pub. No.: US 2007/0296228 A1
(43) Pub. Date: Dec. 27, 2007

(54) System for Manipulating Containers

(76) Inventors: Robert Arthur Mills, Lancashire (GB); Jinbei Tang, Singapore (SG)

Correspondence Address: OSTROLENK FABER GERB & SOFFEN, 1180 AVENUE OF THE AMERICAS, NEW YORK, NY, 100368403, US

(21) Appl. No.: 10/599,224

(22) PCT Filed: Mar. 17, 2005
(86) PCT No.: PCT/SG05/00085

§ 371 Date: Jun. 21, 2007

(30) Foreign Application Priority Data
Mar. 24, 2004 (SG) 200401603-6

(51) Int. Cl. B66C 1/66; B66C 1/10

(52) U.S. Cl. 294/81.1; 294/81.54

(57) ABSTRACT

A spreader assembly for a crane includes a pair of spreaders which are connected by a linking frame and suspended under a trolley. The configuration of the linking frame can be configured using hydraulic cylinders to move the spreaders relatively, so that the spreaders may be used at the same time to carry containers. The linking frame can also be connected to a docking station mounted on the trolley, and either one of the spreaders released from the linking frame for independent use.

### FIELD OF THE INVENTION

The present invention relates to systems for transferring containers, and particularly, though not exclusively, to systems for loading containers onto ships and unloading containers from ships.

### BACKGROUND OF INVENTION

There has been much progress in recent years in providing improved mechanisms for loading containers into ships and unloading them. These mechanisms have permitted the size of the containers to increase, while the rate at which containers can be loaded and unloaded has also been increased.

Generally, systems for moving containers employ a “spreader” is which is a frame having a generally rectangular profile, and including twistlocks at its four corners. The spreader is typically suspended in a generally horizontal orientation by cables from a trolley which is in turn supported on a crane. The trolley can be moved along a track on the crane, and the spreader can be raised or lowered by playing out or reeling in the cables. The track extends from a first position which is directly above a ship, to a second position which is directly above an area of the quayside onto which containers may be positioned (e.g. onto a loading surface of a vehicle parked in that area). To manipulate a container (e.g. in the ship or on the quayside), the spreader is lowered onto a container such that the twistlocks overlie the corners of the container, and the twistlocks are connected to the container. The spreader is then lifted using the cables, and the trolley is moved along the track. The spreader is then lowered again, and the twistlocks are released to deposit the container in the desired location.

In order that there is little risk of the spreaders colliding with the trolley, the cable mechanism is conventionally designed such that the spreaders never come closer than a pre-determined spacing from the trolleys. That is, there is an exclusion region between the trolley and the spreaders which the spreaders never enter.

One patent application, WO 01/62657 by the present applicant, the disclosure of which is incorporated herein by reference, has proposed a twinlift spreader which is capable of handling two 20 feet containers in end-to-end relationship simultaneously, or alternatively of handling a single 40 or 45 foot container.

Recently there has been discussion in the industry of whether it would be possible to provide a crane with a spreader assembly including two spreader units, to be used simultaneously in combination to hold respective containers. However, to the knowledge of the present inventors no functioning system has been publicly disclosed.

### SUMMARY OF THE INVENTION

The present invention aims to provide a new and useful mechanism for transferring containers, particularly onto and off ships.

In particular, the invention aims to provide a system which makes it possible to provide two spreaders which may be used either together (such as in a side-by-side configuration), or alternatively for at least one of them to be useable separately.

In general terms, a first aspect of the present invention proposes a spreader assembly suitable for attachment to a crane, the mechanism containing two spreader units and a linking frame. Each of the spreader units is releasably attachable to at least one container. The linking frame is configured to be attachable selectively either to both of the spreaders, or to a selected one of them.

Thus, the linking frame makes it possible for the two spreaders to be linked together, such that they can be used simultaneously, or for either one of spreaders to be released from the linking frame so that it can be used on its own while leaving the other spreader unused and connected to the linking frame.

Since the linking frame can be released from either of the spreader units, the operator has the option of which of the spreader units to use and which to leave attached to the linking frame. There are many reasons why an operator might require this freedom. For example, if he becomes aware that one of the spreader units is damaged, he may choose to use the other one.

Furthermore, if the spreader units are movable along a track on the crane with their direction of separation parallel to the length direction of the track, this means that the respective ranges of positions of the two spreaders along the track are different; for that reason it may be preferable for a certain one of the spreaders to be used to reach containers which are near the ends of the track. Note that the extra cost of making the track longer by the width of a spreader may be very great.

Also, under certain arrangement, the operator may be able to achieve a better view of the operation of one of the spreader units than of the other.

The linking frame preferably includes a configuration mechanism which, while the linking frame is attached to both the spreader units, moves the spreader units relative to each other. This configuration mechanism may include one or more hydraulic cylinders having ends which are connected respectively to the two spreader units. Preferably, it includes at least three such cylinders, to provide at least three degrees of freedom in relatively moving the spreaders.

The configuration mechanism is preferable capable of moving the spreader units so as to relatively skew the longitudinal axes of the spreaders by a motion in which the two axes remain in a plane (e.g. such that those longitudinal axes are convergent lines in a common (typically horizontal) plane), and/or of relatively moving the spreader units along their longitudinal axes, and/or of relatively moving the axes of the spreaders so that their axes do not lie in a single plane.

The releasable connection between the linking frame and the spreader units is preferably at, or proximate, respective headblocks which are portions of the spreader units. Each of the headblock units includes pulleys by which the spreader units are connected to the cables which suspend the headblock units from the trolley.

The trolley itself preferably includes, or is in fixed spatial relationship to, a docking station to which the linking frame can be releasably attached. Preferably, the linking frame is attached to the docking station while still connected to both of the spreader units, and the linking frame can subsequently be released from one of the spreader units so that spreader unit can be used independently. The fact that the linking frame is attached to the docking station means that it is relatively easy to reconnect it to the released spreader unit when desired, since the position of the linking frame is well controlled by the docking station.

The concept of providing a docking station provides a second, independent aspect of the present invention, which can be useful even if the linking frame is permanently connected to one of the spreader units (i.e. is not according to the first aspect of the invention).

Conveniently, one or both of the linking frame and docking station includes sockets while the other includes members (“plugs”) which can be received into the sockets. One or both of the sockets and/or plugs may be shaped with a guide profile, such that, when the sockets approach the plugs, contact between the sockets and plugs guides the spreader laterally (i.e. in a direction substantially normal to the vertical) into a predetermined position relative to the docking station.

Preferably, one or both of the linking frame and docking station includes a locking mechanism which releasably locks the linking frame to the docking station when the two are at a predetermined relative position (e.g. when the plugs are in the sockets). This may, for example, be by means of one or more pins mounted on one of the linking frame and docking station, and engagable with the other of the linking frame and docking station.

The invention is not limited in terms of the type of spreader units. For example each of the spreader units may be conventional (e.g. a rectangular frame having twistlocks at the corners), or more preferably be of the type described in WO 01/62657.

### BRIEF DESCRIPTION OF THE FIGURES

Preferred features of the invention will now be described, for the sake of illustration only, with reference to the following figures in which:

FIG. 1 is a first perspective view of an embodiment of the invention in a first configuration;

FIG. 2 is a perspective view of a portion of the embodiment of FIG. 1 in the first configuration and proximate a docking station;

FIG. 3 is a second perspective view of the embodiment of FIG. 1 in a variant of first configuration;

FIG. 4 is a first perspective view of the embodiment of FIG. 1 in a second configuration;

FIG. 5 is a second perspective view of the embodiment of FIG. 1 in the second configuration;

FIG. 6 is a first perspective view of an embodiment of the invention in a third configuration; and

FIG. 7 is a second perspective view of the embodiment of FIG. 1 in the third configuration.

### DETAILED DESCRIPTION OF THE EMBODIMENTS

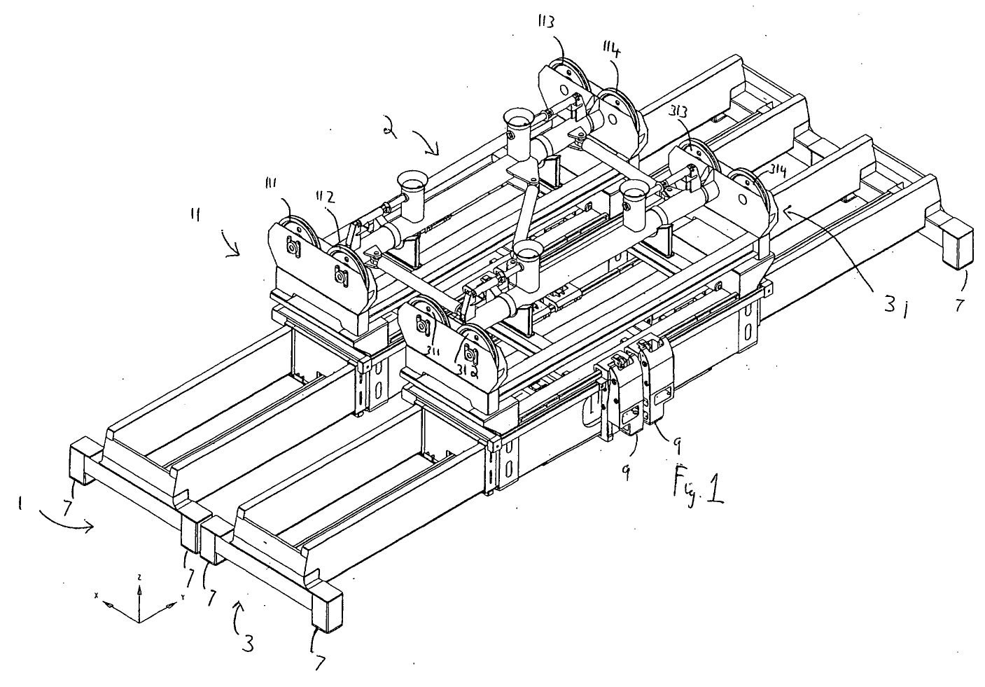

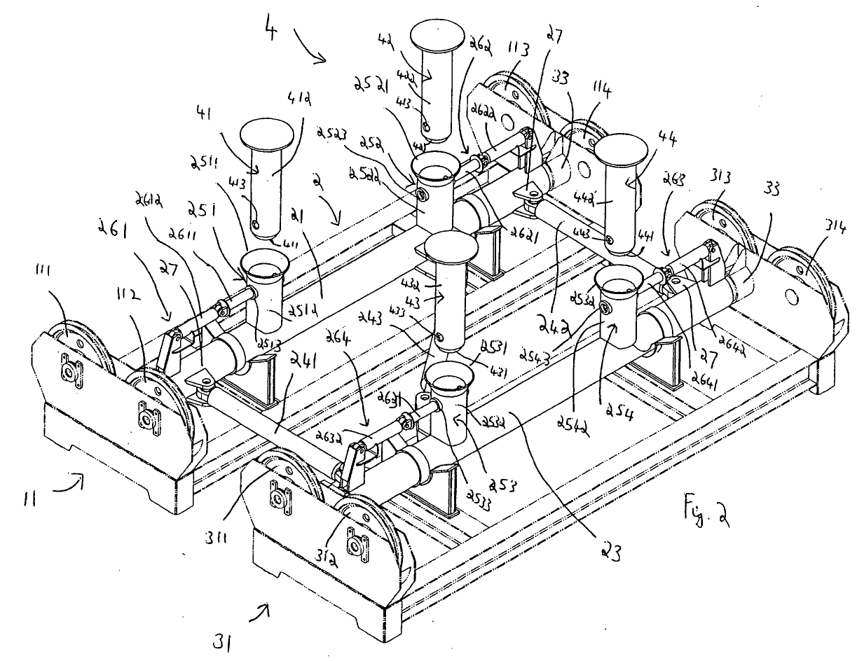

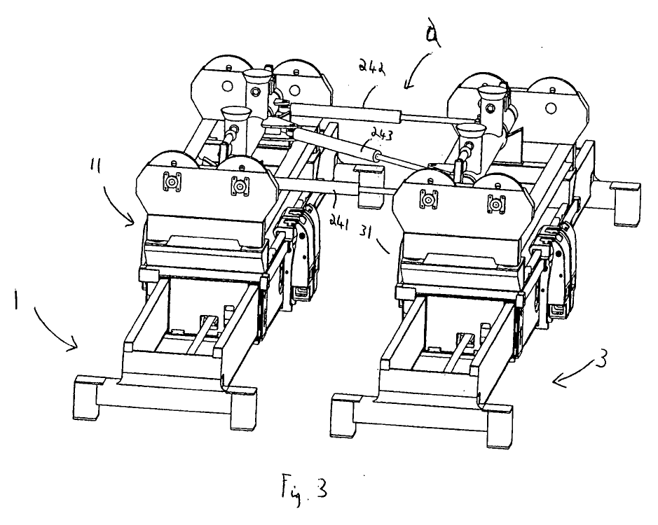

Referring firstly to FIGS. 1 to 2, an embodiment of the invention is shown in a first configuration, and in FIG. 3 in a variant of this configuration. The embodiment is a spreader assembly which includes two spreader units 1, 3 (from now on referred to simply as “spreaders”). Each of the spreaders 1, 3 includes a respective headblock unit 11, 31. A linking frame 2 extends between the headblock units 11, 31. The headblock units include pulleys 111, 112, 113, 114, 311, 312, 313, 314 by which the spreader assembly is suspended beneath a trolley (not shown) by means of cables. The trolley is typically mounted on a track on a crane as in conventional systems. The position of the spreaders 1, 3 in relation to the trolley can be controlled by moving the cables. The mechanisms for providing this control will be well understood by one skilled in this field.

In the configurations shown in FIGS. 1, 2 and 3, the spreaders 1, 3 are connected by the linking frame 2 and moved as a unit. This means that the spreaders 1, 3 can be used to pick up respective containers using twistlocks 7 provided at the corners of the spreaders 1, 3. To do this, the four twistlocks 7 of each spreader are connected to the four respective corners of the respective container. Furthermore, the spreaders 1, 3 may be of the type described in WO 01/62657, such that they include additional twistlocks 9 at an intermediate position, such that each spreader 1, 3 can pick up two shorter containers, each being supported by two of the twistlocks 7 and two of the twistlocks 9. As further described in detail in WO 01/62657, the spacing of the twistlocks 7 from the twistlocks 9 may be controllable for additional flexibility.

The linking frame 2 is seen most clearly in FIG. 2, which shows the top portion (linking frame 2 and headblocks 11, 31) of the spreader assembly in the configuration of FIG. 1 at a time when the top portion is just below a docking station (described below). In FIG. 2, the headblock units 11, 31 are shown dashed.

The linking frame 2 includes two main cylinders 21, 23. At each end of each of the cylinders 21, 23 are rods (not shown) which are controllable to move between a first extended position in which they extend out of the ends of the cylinders 21, 23, and second retracted position in which they are within the ends of the cylinders 21, 23.

The cylinders 21, 23 can be attached to the respective headblocks 11, 31 by the following steps. For simplicity, the steps of connecting the cylinder 21 to the headblock 11 are described, but the same steps apply to connecting the cylinder 23 to the headblock 31. Firstly, at a time when the rods at the ends of the cylinder 21 are in the retracted configuration, the cylinder 21 is located between two sockets on the headblock 31 (only one of these sockets 33 is visible in FIG. 2, but there is another identical socket at the other end of the cylinder 21). Then the rods are extended from the ends of the cylinder 21 and enter the sockets 33. Conversely, the cylinder 21 can be separated from the headblock 31 by withdrawing the rods at its ends from the sockets 33.

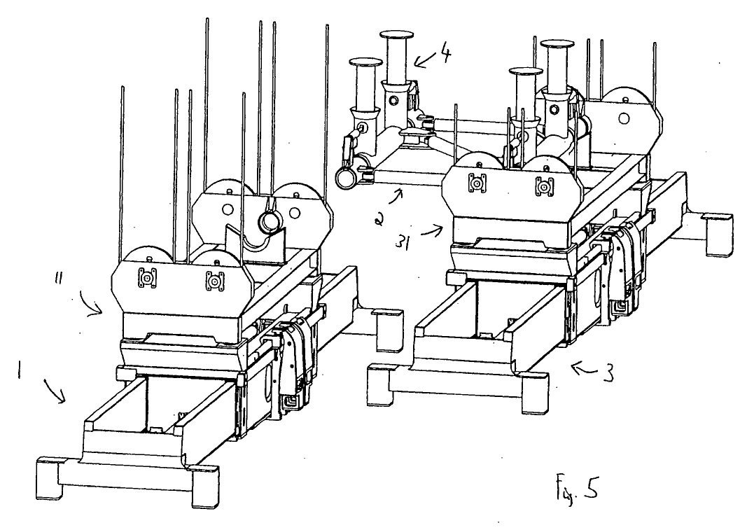

The linking frame further includes a configuration mechanism including three hydraulic cylinders 241, 242, 243 connecting the two cylinders 21, 23. These include: a first hydraulic cylinder 241 extending between positions on the cylinders 21, 23 proximate a first of their ends (the left ends as shown in FIG. 2); a second hydraulic cylinder 242 extending between positions on the cylinders 21, 23 proximate their other ends (their right ends as shown in FIG. 5); and a third hydraulic cylinder 243 extending between a position on one cylinder 21 proximate one of its ends (the right end as shown in FIG. 2) and a position on the other cylinder 23 proximate the other one its ends (the left end as shown in FIG. 2).

As shown in FIG. 2, the spreader assembly is in a configuration in which the cylinders 21, 23 are side-by-side and parallel. The hydraulic cylinders 241, 243 are normal to the longitudinal axes of the cylinders 21, 23. In this configuration the vertical direction is shown in FIG. 1 as z, the length direction of the cylinders 21, 23 as y, and the spacing direction as x. However, the extension and retraction of the hydraulic cylinders 241, 242, 243 can be varied independently, so that the relative positions of two cylinders 21, 23 (and therefore the relative positions of the headblocks; and therefore the spreaders attached to them; and therefore in turn containers attached to the spreaders) can be manipulated.

For example, the cylinders 241, 242, 243 can be positioned such that the cylinders 21, 23 are side-by-side but their length directions are not parallel. In a first such case, the longitudinal axes of the cylinders 21, 23 may converge towards one end, while still lying in a shared plane; this is called “skew”. In a second such case, the longitudinal axes of the cylinders 21, 23 may not lie in a shared plane, i.e. one of the headblocks may be tipped forwards relative to the other (i.e. if one of the cylinders 21 is horizontal, the other is not). Alternatively, the cylinders 241, 242, 243 can be positioned so that the length directions of the cylinders 21, 23 are parallel, but the cylinders are relatively displaced from the other along this direction. Combinations of these positionings are possible. Thus, when an operator desires to lift two containers which are not originally exactly parallel he can do so by appropriately manipulating the spreaders 1, 3 onto them. Furthermore, when the operation desires to position the containers, he can do so even when the containers are not to be positioned on a horizontal surface (e.g. if they are to be positioned onto the respective loading surfaces of two trailers, when those surfaces are not necessarily parallel).

The three degrees of freedom given by the cylinders 241, 242, 243 give the operator great flexibility in handling containers. For example, this flexibility allows the containers to be placed easily into the “guides” which are provided in some modern ships for manipulating containers on-board the ship. Note that when the container(s) supported by one of the spreaders 1, 3 has been landed, manipulating the other spreader typically becomes much easier.

The hydraulic cylinders 241, 242, 243 preferably include linear transducers (or similar measuring devices) to determine the extent to which they are extended. The outputs of these measuring devices can be fed to the operator, or to an automatic control system. The measuring devices may optionally be provided within the cylinders 241, 242, 243 to reduce the risk that they are damaged. The cylinders 241, 242, 243 may be mounted on the cylinders 21, 23 by hinged connections 27 having a hinge direction substantially normal to the length direction y of the cylinders, and to the x-direction in which the cylinders 21, 23 are spaced apart. This means that the cylinders are not obliged to bear torsion forces in the plane normal to the hinge. Furthermore, pressure release valves are preferably provided to ensure that the cylinders are not subject to extreme forces parallel to their length.

Optionally, an anti-collision device (not shown) may be provided between the spreaders to ensure that they do not approach closer than a certain minimum distance, or to buffer their motion if they do. This may optionally be additional to the cylinders 241, 242, 243, and/or by implemented as an automated control system for controlling the extension of the cylinders 241, 242, 243.

The linking frame further includes a plurality of sockets 251, 252, 253, 254, and for each socket a respective locking mechanism 261, 262, 263, 264. The sockets 251, 252, 253, 254 include frusto-conical guide lips 2511, 2521, 2531, 2541 and hollow cylindrical portions 2512, 2522, 2532, 2542. The locking mechanisms 261, 262, 263, 264 include respective pins 2611, 2621, 2631, 2641 and drive mechanisms 2612, 2622, 2632, 2642 to move the pins between a retracted configuration in which they do not enter the sides of the hollow cylindrical portions 2512, 2522, 2532, 2542, and an extended configuration in which they project through holes 2513, 2523, 2533, 2543 in the respective sockets, across the centres of the hollow cylindrical portions 2512, 2522, 2532, 2542, and out of holes on the other side of the respective sockets.

The sockets 251, 252, 253, 254 are used to receive respective plugs 41, 42, 43, 44 of a docking station, typically mounted on the bottom of the trolley. The plugs 41, 42, 43, 44 include respective narrowed end portions 411, 421, 431, 441 and body portions 412, 422, 432, 442. The body portions include respective cylindrical holes 413, 423, 433, 443 extending through them parallel to the longitudinal axes of the cylinders 21, 23.

When the linking frame is raised (by raising the two headblocks to which it is at that time attached) it encounters the docking station (which may be treated as fixed), and the guide lips 2511, 2521, 2531, 2541 guide the end portions 411, 421, 431, 441 of the respective plugs 41, 42, 43, 44 to bring the plugs 41, 42, 43, 44 into register with the sockets 251, 252, 253, 254. Thus, when the linking frame is raised further, the body portions 412, 422, 432, 442 enter the respective hollow cylindrical portions 2512, 2522, 2532, 2542.

When the plugs 41, 42, 43, 44 have fully entered the respective hollow cylindrical portions 2512, 2522, 2532, 2542, the respective locking mechanisms 261, 262, 263, 264 lock the plugs in place by the drive mechanisms 2612, 2622, 2632, 2642 moving the respective pins 2611, 2621, 2631, 2641 into their extended configuration. During this movement, the pins thread through respective holes 413, 423, 433, 443 in the plugs 41, 42, 43, 44.

When it is desired to release the linking frame 2 from the docking station, the drive mechanisms 2612, 2622, 2632, 2642 retract the respective pins 2611, 2621, 2631, 2641 into their retracted configuration, which permits the linking frame 2 to be removed from the docking station simply by lowering the linking frame (i.e. by lowering the headblocks 11, 31 using the pulleys), until the plugs 41, 42, 43, 44 exit the sockets 251, 252, 253, 254.

Note that the plugs 41, 42 may in different versions of this embodiment be provided at different positions relative to the plugs 43, 44, since, for example, whatever the spacing between the plugs 41, 42 and the plugs 43, 44, an appropriate setting of the hydraulic cylinders 241, 242, 243 would allow the plugs 41, 42, 43, 44 to be connected respectively to the sockets 251, 252, 253, 254. However, preferably the plugs 41, 42, 43, 44 are arranged such that the spacing between the points at which the cables are connected to the headblocks 11, 13 is substantially the same respectively as the spacing between the points at which the cables are connected to the trolley, so that in the configuration of FIG. 2 the cables are at a relatively low angle to the vertical (note that when the linking frame is proximate the docking station the length of the cable between the docking station and the linking frame is relatively short). The reason for preferring this possibility is that this means that the docking station 4 and cables are not forced to bear opposing lateral forces. In some such arrangements the angles between the cables and the vertical direction will be low if the linking frame can be connected to the docking station when the hydraulic cylinders 241, 242, 243 are at, or near, their minimum length configuration, i.e. such that the headblocks 11, 31 are at, or near, their closest approach. This is illustrated in FIG. 2.

Note that the drive mechanisms of the linking frame 2 are typically powered by an electric power cable (not shown in the figures), such as one extending from the trolley to the linking frame. Optionally, there may be more than one power cable, e.g. two cables for carrying power for the pin and rod drive mechanisms of the respective cylinders 21, 23. The linking frame further receives control signals through a cable (optionally attached to, or even part of) the power cable. These cables are typically additional to the respective power cables and/or control cables which extend from the trolley to each spreader for controlling the operation of each spreader. A reeler mechanism may be provided on the trolley for reeling in the cable(s) as the linking frame is raised, or for playing out the cable(s) as the linking frame is lowered. The reeler may include a drive mechanism which can be operated at variable speeds, according to the variable speeds at which the spreader is raised at different speeds (as described below).

Preferably, the rod drive mechanisms which drive the rods at the ends of the cylinders 21, 23 are hydraulic and contained within the respective cylinders 21, 23; this reduces the risk of the drive mechanisms being damaged in use. The rod drive mechanisms may employ one or more oil reservoirs which, likewise, are preferably provided within the cylinders 21, 23. Note that the ends of the rods may be shaped such that when they approach the headblocks they guide the cylinders 21, 23 laterally relative to the headblocks 11, 31. For example, the ends of the rods may be narrowed (i.e. V-shaped as viewed from the side).

The control system which controls the rod drive mechanisms, and the pin drive mechanisms 2612, 2622, 2632, 2642 of the locking mechanism, preferably controls them such that at least one of the cylinders 21, 23 is attached to the respective headblock 11, 31 at any time by the respective pair of rods, and such that the rods of either one of the cylinders 21, 23 are only released from the respective headblock at a time when the linking frame 2 is attached to the docking station by the pins 2611, 2621, 2631, 2641.

In order for the control system to be capable of ensuring that these conditions are met, the sockets 251, 252, 253, 254 preferably include sensors for detecting when the respective plugs 41, 42, 43, 44 are correctly locked into them. Furthermore, in order to ensure that excessive forces are not generated by the impact of the bottoms of the plugs 41, 42, 43, 44 against the inside surfaces of the sockets 251, 252, 253, 254, each of the sockets 251, 252, 253, 254 preferably contains a resilient buffer member, such as a rubber block, to prevent a “steel-on-steel” collision. This buffer member preferably accepts 50-60 mm of compression.

Note that when the spreaders 1, 3 are connected to the docking station via the linking frame 2 they may be in the exclusion region into which (as described above) conventional spreaders do not enter. In order to ensure that the spreaders 1, 3 do not collide with the trolley, the cable control mechanism may be designed such that when one of the spreaders 1, 3 is closer than a predetermined distance below the trolley that spreader 1, 3 can only be raised at a speed which is lower than the maximum lifting speed when the spreader is more than the predetermined distance below the trolley. Alternatively or additionally, one or more proximity sensors may be provided (on the trolley and/or the spreader assembly) to monitor the spacing between one or both of the spreaders 1, 3 and the trolley, and send a signal to stop the spreader(s) 1, 3 (or at least reduce their upward velocity) when they are closer to the trolley than a predetermined distance.

FIG. 3 shows the spreader assembly in the same basic configuration as FIGS. 1 and 2, except that the hydraulic cylinders 241, 242, 243 are in an extended state, pushing the headblocks 11, 31 apart.

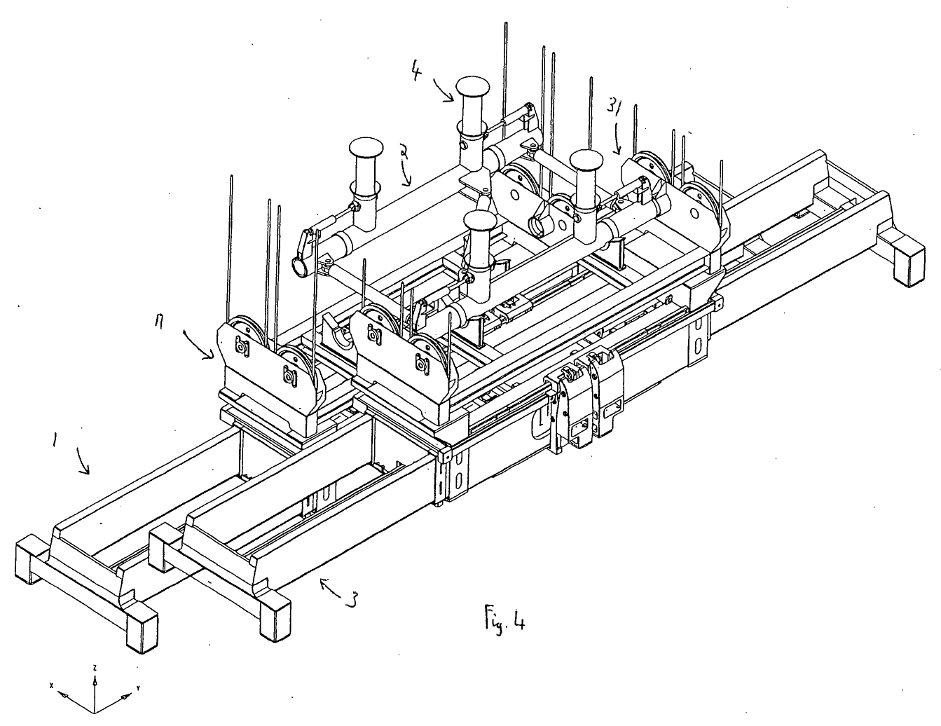

FIGS. 4 and 5 show the spreader assembly in a second configuration, in which the linking frame 2 is locked to the docking station 4, while being attached to the spreader 3. The spreader 1 can then be moved independently to carry loads, while leaving the spreader 3 unused.

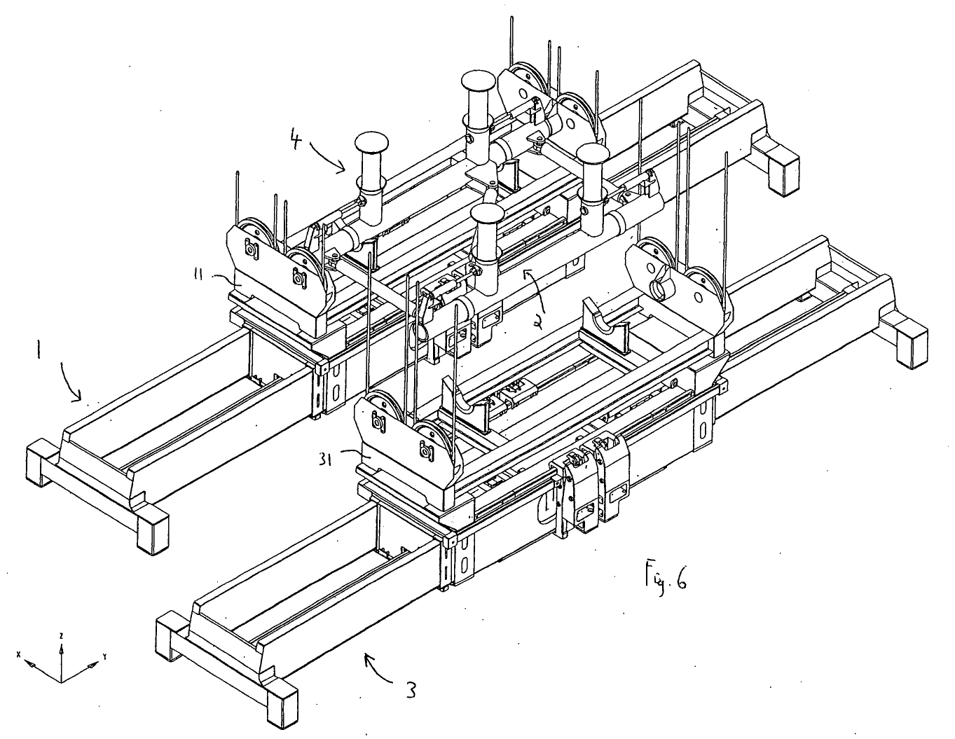

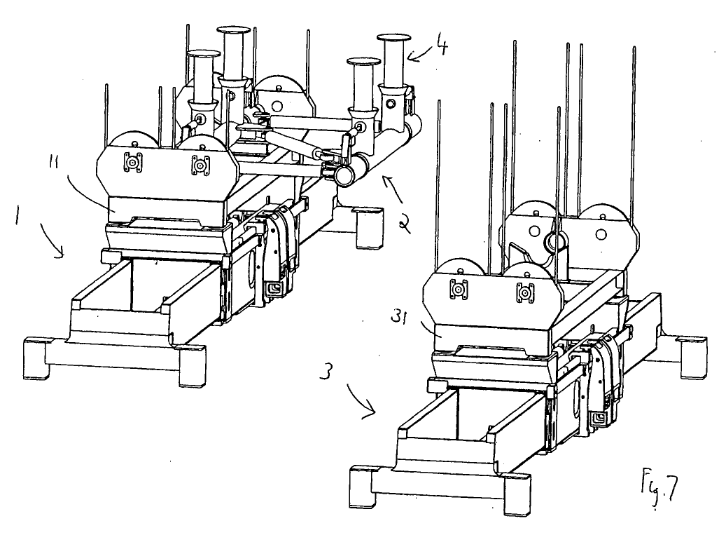

FIGS. 6 and 7 show the spreader assembly in a third configuration, in which the linking frame 2 is locked to the docking station 4, while being attached to the spreader 1. The spreader 3 can then be moved independently to carry loads, while leaving the spreader 1 unused.

Thus, in summary, in use the spread assembly may be used in a first mode of operation to pick up and deposit one or more containers while the spreaders 1, 3 are attached to each other (as in FIGS. 1, 2 and 3).

When it is desired to cease using the spreader 1 (e.g. because it is damaged), the spreaders can be raised as shown in FIG. 2 and the linking frame 2 locked to the docking station 4 on the trolley. At this stage, the connection between the spreader 3 and the linking frame 2 is released, leaving the linking frame 2 and the spreader 1 fixed in a known position in relation to the trolley. This is shown in FIGS. 6 and 7. The spreader 3 can then be used independently, as in conventional systems. When it is again desired to use the spreader 1, the spreader 3 can be raised and locked to the linking frame 2. The linking frame 2 can then be released from the docking station 4, returning the spreader assembly to the configuration shown in FIG. 1 or FIG. 3.

When it is desired to cease using the spreader 3 (e.g. because it is damaged), the spreaders can be raised as shown in FIG. 2 and the linking frame 2 locked to the docking station on the trolley. At this stage, the connection between the spreader 1 and the linking frame 2 is released, leaving the linking frame 1 and the spreader 3 fixed in a known position in relation to the trolley. This is shown in FIGS. 4 and 5. The spreader 1 can then be used independently, as in conventional systems. When it is again desired to use the spreader 3, the spreader 1 can be raised and locked to the linking frame 2. The linking frame 2 can then be released from the docking station 4, returning the spreader assembly to the configuration shown in FIG. 1 or FIG. 3.

While only a single embodiment of the invention has been described above, many variations are possible within the scope of the invention.

For example, whereas in the embodiment described above all the mechanism for locking the linking frame to the docking station is provided on the linking frame (which gives the advantage that the invention can be implemented without making major differences to the trolley of existing cranes, apart from the provision of the plugs 41, 42, 43, 44), in other embodiments the locking mechanism may be provided on the docking station.

Furthermore, in some embodiments of the invention the cab in which the crane operator works may be movable so as to give the operator a better view of the connection between the linking frame and the docking station.

Furthermore, while the invention has been described above on the assumption that the spreader assembly includes only two spreaders 1, 3, in principle it may comprise further spreaders, permitting an even greater number of containers to be carried at once. For example, there may be three spreaders connected pairwise by two linking frames. Any of these containers may be releasable for independent movement while the other spreaders and the linking frames remain fixed to a docking station.

As a further example, whereas in the embodiment described above, the linking frame can be released from, and reconnected to, both of the spreaders, in other embodiments (within the scope of the second aspect of the invention but not the first) the linking frame may be releasable only from one of the spreaders. For example, such an embodiment could be obtained from the embodiment described above simply by omitting the mechanism which retracts the rods from the ends of the cylinder 23, such that the rods are permanently in the extended configuration and the linking frame 2 is permanently connected to the cylinder 23.

In this case, the spreader 3 cannot be used independently (because the linking frame 2 prevents the spreader 3 from being lowered past the spreader 1), although the spreader 1 can be used independently (e.g. when the linking frame 2 is connected to the docking station 4). However, it is possible to provide further embodiments in which the linking frame is retractable such that its lateral extension is within the profile of the spreader 3, so that the spreader 3 can indeed be lowered past the spreader 1 if required.

1. A spreader assembly comprising:
two spreader units, each spreader unit being for releasable attachment to at least one container;
a linking frame releasably connectable selectively either to both of the spreaders, or to a selected one of them, wherein the spreaders include respective headblock units, the linking frame releasably connectable to the spreaders via the headblock units.

2. A spreader assembly according to claim 1 in which the linking frame comprises a configuration mechanism which, while the linking frame is connected to both the spreader units, is operative to move the spreader units relative to each other.

3. A spreader assembly according to claim 2 in which the configuration mechanism includes one or more hydraulic cylinders having ends which are in fixed spartial relationship respectively to the two spreader units when the linking frame is connected to both the spreader units.

4. A spreader assembly according to claim 3 comprising at least three hydraulic cylinders, said hydraulic cylinders being independently controllable.

5. The spreader assembly according to claim 4 wherein the hydraulic cylinders are arranged in a common plane with two of said cylinders parallel and spanning between said spreader units and the third cylinder placed intermediate the parallel cylinders and inclined to an axis defined by the parallel cylinders.

6. A spreader assembly according to claim 2 in which the configuration mechanism is operative to move the spreader units:
(i) to relatively move the spreader units while the longitudinal axes of the spreaders remain in a plane,
(ii) to relatively move the spreader units such that their axes do not lie in a single plane, and
(iii) to relatively move the spreader units along their longitudinal axes.

7. A spreader according to claim 6 in which the releasable connection between the linking frame and the spreader units is at or proximate end portions of said respective headblocks.

8. A spreader assembly according to claim 1 in combination with a docking station which is in fixed positional relationship to a trolley from which the spreader assembly is suspended, the linking frame being lockable to the docking station.

9. A combination of a trolley and a spreader assembly suspended from the trolley,
the spreader assembly comprising two spreader units, each spreader unit being for releasable attachment to at least one container, and a linking frame connected to both the spreaders and releasable from at least one of them; and
the trolley comprising a docking station, the linking frame being lockable to the docking station.

10. A combination according to claim 9 in which one or both of the linking frame and docking station includes one or more sockets while the other includes plugs which can be received into the sockets.

11. A combination according to claim 9 in which a resilient buffer is provided to cushion impact between the or each socket and the respective plug.

12. A combination according to claim 10 in which one or both of the sockets and/or plugs are shaped with a guide profile, such that, when the sockets approach the plugs, contact between the sockets and plugs guides the spreader laterally into a predetermined position relative to the docking station.

13. A combination according to claim 10 in which one or more locking mechanisms are mounted on a first one of the linking frame and docking station, the or each locking mechanism being operative when the plugs are in the sockets to releasably engage with said plugs or sockets on the other one of the linking frame or docking station to lock the locking frame to the docking station.
